(19) United States
(12) Patent Application Publication
(10) Pub. No.: US 2006/0155811 A1
(43) Pub. Date: Jul. 13, 2006

(54) System and method for mobile e-mail management

(76) Inventors: Han Leong Goh, Singapore (SG); Kok Kong Tan, Singapore (SG)

Correspondence Address: FULWIDER PATTON, 6060 CENTER DRIVE, 10TH FLOOR, LOS ANGELES, CA, 90045, US

(21) Appl. No.: 10/549,045

(22) PCT Filed: Mar. 10, 2004
(86) PCT No.: PCT/SG04/00049

§ 371 Date: Sep. 12, 2005

Related U.S. Application Data
(60) Provisional application No. 60/452,936, filed on Mar. 10, 2003.

(51) Int. Cl. G06F 15/16

(52) U.S. Cl. 709/206

(57) ABSTRACT

The present invention provides a system and method for e-mail management utilising a mobile device comprising the steps of establishing a link between the mobile device and a computer device, establishing a link between the computer device and a mail server, browsing through data files on the computer device under the control of the mobile device and attaching one or more of the data files, under the control of the mobile device, to an e-mail to be send utilising the mail server.

### FIELD OF THE INVENTION

The invention relates broadly to the field of mobile computing. As an example, the present invention is embodied in a complete mobile email management system and method based on WAP (Wireless Application Protocol) E-mail service.

### BACKGROUND OF THE INVENTION

E-mail has been lauded as “the next quantum step toward human freedom”; it allows us to make contacts with people all over the world at an instant. However, this freedom is restricted to the nearest online terminal. With the invention of WAP enabled hand-held mobile devices (e.g. mobile phone and PDA) the boundary of E-mail is now expanded; we can now read, send and reply to E-mail via the hand-held mobile devices.

However, the current WAP E-mail services lack an important Internet email function: The ability to attach and view files. This is a significant setback as one of the reasons for E-mail's amazing success is its ability to send attachments. For example, documents, pictures and birthday cards can be sent instantly to the recipient without incurring any charges.

Hence, it was with knowledge of the foregoing concern that the present invention was conceived and has now been reduced to practice.

### SUMMARY OF THE INVENTION

According to one aspect of the present invention, there is provided a method for e-mail management utilising a mobile device, the method comprising the steps of, establishing a link between the mobile device and a computer device, establishing a link between the computer device and a mail server, browsing through data files on the computer device under the control of the mobile device and attaching one or more of the data files under the control of the mobile device to an e-mail to be sent utilising the mail server.

The step of establishing the link between the mobile device and the computer device may comprise the steps of establishing a link between the mobile device and an authentication server; verifying, at the authentication server, identification information provided through the mobile device; and establishing the link between the mobile device and the computer device upon successful verification.

The method may further comprise the steps of instructing the computer device to periodically send a User Datagram Protocol (UDP) packet to the authentication server when on-line; extracting, at the authentication server, a public Internet Protocol (IP) address allocated to the received UDP packets; and utilizing the extracted public IP address for establishing the link between the mobile device and the computer device.

The method may further comprise the step of monitoring the arrival of new e-mails at the mail server and sending one or more messages to the mobile device when there are new e-mails.

The authentication server may monitor the arrival of new e-mails at the mail server and sends one or more messages to the mobile device when there are new e-mails.

The method may further comprise the step of downloading a data file attached to an e-mail received at the mail server to the mobile device for viewing.

The method may further comprise a file conversion technique to convert the data file to an image file. The file conversion technique may comprise the steps of connecting to an application running the data file; instructing the application to copy a fraction or whole part of the data file into a data storage; and converting the fraction or whole part of the data file stored in the data storage to the image file using an Application Programming Interface (API).

The method may further comprise an image processing technique to resample the image file so as to create a clearer image of the image file when viewed on the mobile device.

The image processing technique may further comprise employing Gaussian blurring process to smoothen out artifacts on the image file.

The mobile device may comprise a zoom function to improve readability of the image file. The zoom function may segment the image of the image file when viewed on the mobile device into one or more selectable regions. A selected region may be cropped from the image of the image file when viewed on the mobile device and magnified for viewing on the mobile device.

The image may be segmented with a single row of one or more columns for text base images.

The image may segmented with two or more rows and two or more columns for picture base images.

The mobile device may resume a network gateway connection after an assigned access time on the network gateway maintaining the connection has expired.

A WML code may be downloaded into the mobile device for resuming the network gateway connection after the assigned access time on the network gateway maintaining the connection has expired.

A user of the mobile device may boot up the computer device utilizing the wake on ring function of the computer device.

The method may further comprise an authentication device working on dial-tone principle that will authenticate the user before booting up the computer device utilizing the wake on ring function of the computer device.

According to a second aspect of the present invention, there is provided a system for e-mail management, the system comprising a computer device, a mail server, a mobile device, an agent on the computer device to, under the control of the mobile device, browse through data files on the computer device and attach one or more of the data files to an e-mail to be sent utilising the mail server.

The system may further comprise an authentication server, wherein the mobile device establishes a link to the authentication server; the authentication server verifies identification information provided through the mobile device and establishes the link between the mobile device and the computer device upon successful verification.

The computer device, in an on-line state, may periodically send a User Datagram Protocol (UDP) packet to the authentication server under the control of the agent.

The authentication server may extract a public Internet Protocol (IP) address allocated to the received UDP packets and utilizes the extracted public IP address for establishing the link between the mobile device and the computer device.

The authentication server may monitor the arrival of new e-mails at the mail server and sends one or more messages to the mobile device in response to receipt of new e-mails.

The mobile device may download and view a data file attached to an e-mail received at the mail server.

The system may utilize a file conversion technique to convert the data file to an image file.

The file conversion technique may comprise the steps of connecting to an application of the system running the data file; instructing the application to copy a fraction or whole part of the data file into a data storage; and converting the fraction or whole part of the data file stored in the data storage to the image file using an API.

The system may further utilize an image processing technique to resample the image file so as to create a clearer image of the image file viewed on the mobile device.

The image processing technique may further comprise employing Gaussian blurring process to smoothen out artifacts on the image file.

The system may utilize a zoom function to improve readability of the image file. The zoom function may comprise segmenting the image of the image file into selectable regions.

A selected region may be cropped from the image of the image file and magnified for viewing on the mobile device.

The image may be segmented with a single row of one or more columns for text base images. The image may be segmented with two or more rows and two or more columns for picture base images.

The mobile device may resume a network gateway connection after an assigned access time on the network gateway maintaining the connection has expired.

The mobile device may execute a WML code for resuming the network gateway connection after the assigned access time on the network gateway maintaining the connection has expired.

The mobile device may boot up the computer device utilizing the wake on ring function of the computer device.

The computer device may authenticate the mobile device before booting up.

According to yet another aspect of the present invention, there is provided a data storage device containing computer readable code means for instructing a computer system to execute a method for e-mail management utilising a mobile device, the method comprising the steps of establishing a link between the mobile device and a computer device, establishing a link between the computer device and a mail server, browsing through data files on the computer device, under the control of the mobile device, and attaching one or more of the data files, under the control of the mobile device, to an e-mail to be send utilising the mail server.

### BRIEF DESCRIPTION OF THE DRAWINGS

The accompanying drawings, incorporated into and forming a part of the specification illustrate several aspects of an embodiment of the present invention and, together with the description, serve to explain the principles of the invention. In the drawings:

FIG. 1. The figure shows communication between an Agent and a mobile device using a Thin Target and/or a Target/Server model.

FIG. 2. The figure shows in more detail the communication between the various components in the architecture as shown in FIG. 1.

FIG. 3. The figure shows a PC sending a UDP packet to a server at a regular time interval.

FIG. 4. The figure illustrates the use of clipboard to convert a chart in an Excel file to bitmap format. Note that beside enhanced windows metafile format, the chart is also stored in other clipboard format.

FIG. 5. The figure shows a resampled image of 130×90 pixels. The resampling scale is approximately 5 times. The cellular phone used is a Nokia 6610 model. Observe that the text wordings have been distorted and are unreadable.

FIG. 6. The figure shows an image that is Gaussian blurred with a convolution radius of 3 before resampling.

FIG. 7. The figure (a) on the right shows the original image has been split into four equal length square region, (b) on the left shows the image has been split into four rectangular region.

FIG. 8. The figure shows using the zoom function to enlarge the processed image in FIG. 7.

FIG. 9. The figure shows an average of 300 s is set for the timeout period.

FIG. 10. The figure shows a small WML code downloaded into the hand-held mobile devices during transaction. It re-established the connection between the hand-held mobile devices and the agent when the timeout take place.

### DETAILED DESCRIPTION

The embodiment described enables the user to enjoy the full service available in the Internet E-mail service in terms of 1) sending files from their remote home/office computer devices (e.g. personal computers, laptop) as attachments to the email using a mobile device (e.g. mobile phone and PDA), 2) Open and view attachment file in the received E-mail, and 3) Access Web-based E-mail server. The embodiment runs on all types of WAP enabled hand-held mobile devices with color screen display. This includes cellular phone with small display screen and limited memory and storage space.

In detail, the present invention as described in the example embodiment enables sending file(s) residing on one or more remote targeted devices (e.g. personal computers, laptop, Network server, mobile devices) as a file attachment (with the option to zip the file) in a composed WAP E-mail on a mobile device (eg. PDA, Handphone, Notebook). The example embodiment also enables access of Web-based email service (e.g. Hotmail) and reading the attachment in the received email as image or as text on the mobile device. It is noted that in the following description of the example embodiment, a target Personal Computer (target PC) is used to indicate the remote targeted device.

The example embodiment also comprises an attachment function. For example, this attachment function comprises the ability for a user to access his/her home PC (target PC) using a mobile device and attach any file residing in his/her home PC as an attachment file to the composed E-mail on the mobile device.

The example embodiment further comprises file conversion techniques for the user to convert an attached file in a received email to an image file format or text format. For example, the resultant image file can be viewed via Multimedia Messaging Service (MMS), while the resultant text can be viewed via WAP. It is noted that to allow the resultant image file to be viewed on mobile devices with small display area, resampling is required. However, as a result, significant artefacts may be introduced into the resampled image file. Thus, the example embodiment may further comprise image processing techniques, which is additionally used to improve the image quality. This image processing technique will be described later.

In addition, the file conversion techniques for accessing the file attachments in emails can also be applied to mobile education. For example, by converting education materials (e.g. Excel, Word documents) to image files, a student can view his lecture notes in a remote PC using hand-held mobile devices. The file conversion techniques will be described in detail later.

Moreover, the example embodiment comprises a distributed system to connect users' mobile devices to the target PC. The benefits in using a distributed system include saving resources and scalability. However, in most LANs (Local Area Network), Network Address Translation poses a problem for this distributed system. This is due to the fact that in the distributed system, mobile devices need to initiate the connection first. Without knowing the translated address, this connection cannot be established. As such, the example embodiment further comprises a method to overcome this problem. This method will be described later.

In the example embodiment, it is assumed that there are basically three types of E-mail server, POP (Post Office Protocol), IMAP (Internet Message Access Protocol) and Web-based (e.g. Hotmail). Most WAP E-mail services are not able to connect to Web-based E-mail server unless there is a prior agreement between the mobile device user's telecommunication company and the particular web-based Email service of interest. Thus, generally, users of their mobile devices will not be able to access their E-mail in the Web-based E-mail server because the connection cannot be established. As such, the example embodiment further comprises a way to manipulate the Hyper Text Transfer Protocol (HTTP) and/or Hyper Text Transfer Protocol Secure (HTTPS) protocol so as to enable user access to the Web-based Email service using their mobile devices.

Furthermore, the example embodiment comprises a WAP Gateway, which is a server that sits on the Internet and translates data into a format that is compatible for mobile devices. With most WAP Gateways, timeout error usually occurs when the application takes a long time to process a particular task. As the WAP gateways are manned by telecommunication companies, the timeout period cannot be changed. As such, the example embodiment further comprises a software solution to resolve the timeout error issue. This software solution will be described later.

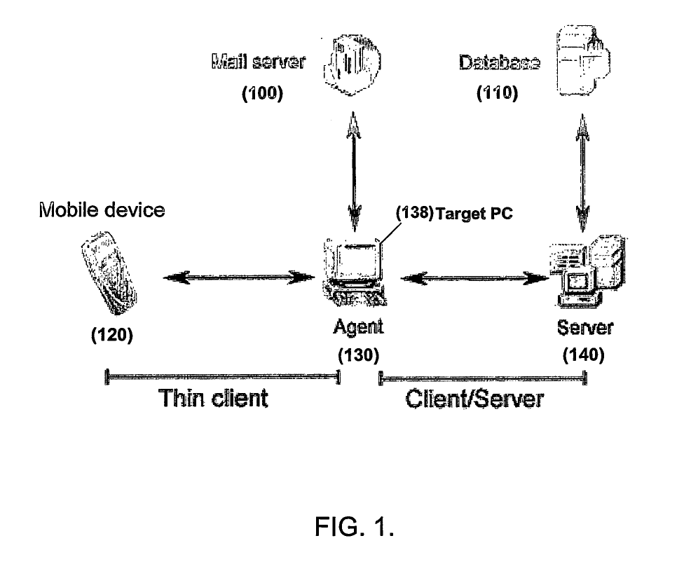

In detail, FIG. 1 shows the proposed architecture of the example embodiment comprising a hybrid Thin target and Target/server model.

In FIG. 1, a mobile device (120) and an agent (130), that is a program running on a target PC (138), exhibit a Thin target relationship. Adopting this model has several advantages. Firstly, the mobile device (120) does not need to install any program. This simplifies system development as there is no need to consider the low hard disk size of the mobile device (120). Secondly, the inter polarity is enhanced as different mobile devices (120) with the same type of WAP browser will be able to view the output of agent (130) correctly.

The Agent (130) acts as a central server to forward and initiate actions between the mobile device (120) and other servers. It allows users to read mails remotely. To do that, it retrieves emails from a web-based Mail Server (100), which can be a POP3, IMAP, or a web-based server. In order to retrieve email from the web-based Mail server (100), the Agent (130) will first establish a HTTP or HTTPS connection with the web-based Mail server (100). If the target PC accesses the Internet via a proxy server, the Agent (130) will have to additionally establish contact with the proxy server of an Internet Service Provider (ISP) before setting up the HTTP and/or HTTPS connection with the web-based Mail Server (100) via the proxy server.

In addition, the Agent (130) allows the user to attach any file in the target PC to the composed email on the mobile device. To implement this service, a File I/O Application Programming Interface (API) is used to enable the Agent (130) to browse through the file directory in the target PC and to copy the designated file to the email multipart through the file streaming function in File I/O API.

To improve on the security and usability of the system, the Thin target model can be extended to encompass a Target/Server part in the wired network. In the Target/Server portion of the system, the roles of Agent (130) have been switched to act as a target.

The function of the server (140) is to provide authentication and perform “offline” tasks like Short Message Service (SMS) alert and user profile maintenance. “Offline” tasks are defined as processes that take place without the user's mobile device (120) being connected to the agent (130).

If just a pure Thin target model is used, users will have to send their email account user ID and password to the agent (130) each time they want to access their email. This may prove to be a security hazard. With the use of Target/Server component in the hybrid model of the example embodiment, the user will first need to log into the Server (140) for authentication. The Server (140) will then retrieve an encrypted user ID and password from a database (110) and match against those provided by the user. Upon positive verification, the Server (140) will redirect the user to his/her target PC. Upon user access into the Agent (130), the Agent (130) will retrieve the encrypted password from the Database (110) and make a direct connection with the specific Mail server (100) (e.g., Hotmail and POP3 servers), thus relieving the user from a redundant chore of having to enter the data on the mobile devices (120) since authentication has already been performed.

The Server (140) will monitor the arrival of new emails at the Mail server (100) of the user. Upon detection of the arrival of a new email, the Server (140) will send a SMS (Short Message Service) alert via a SMS gateway to the user's pre-selected mobile device (120). The user also has the flexibility to modify his profile (e.g., interval of new mail detection) by logging in to the server (140) via any PC terminal.

Moreover, the Server (140) is responsible for redirecting the authenticated user to his/her associated Agent (130). To be able to do this, the Server (140) has to know the current Internet Protocol (IP) address of the Agent (130). The IP address of the target PC can be a dynamic one, which means that each time the target PC goes online, a different IP address can be assigned to it by the ISP.

The steps for the mechanism that is used to keep track of the dynamic IP address of the target PC are illustrated as follow:
1) The Server (140) will open up a many-to-one type of Transport Control Protocol/Internet Protocol (TCP/IP) port.
2) When the target PC goes online, the Agent (130) will establish a TCP/IP connection with the Server (140).
3) The Agent (130) will transmit the IP address and its registration key to the Server (140).
4) Based on the registration key, the Server (140) will update the current IP address of the Agent (130) with the database.
5) The Server (140) will also allocate a connection Identifier (ID) to the Agent (130).
6) When the Agent (130) goes offline, the Server (140) will be notified and based on the connection ID, the Server (140) will update the Agent's (130) status in the database (110) as offline.

The major disadvantage of this system is that when the target PC goes offline, the Server (140) is not informed. The database (110) might contain an outdated IP address. For example, a scenario may occur such that a target PC (A) with an IP address (X) goes offline, and when a target PC (B) goes online, the ISP issues target PC (B) the same IP address (X). When a user (A) using target PC (A) logs into the Server again, he/she will be accessing target PC (B) being used by a user (B).

To prevent the scenario mentioned above from happening, a unique key is implemented. When the user logs into the Server (140), apart from replying with the IP address, the Server (140) also sends a unique key to the user. The user will be redirected to the Agent (130) with the unique key. The Agent (130) will match the unique key to its own to see if the user has the right to access it.

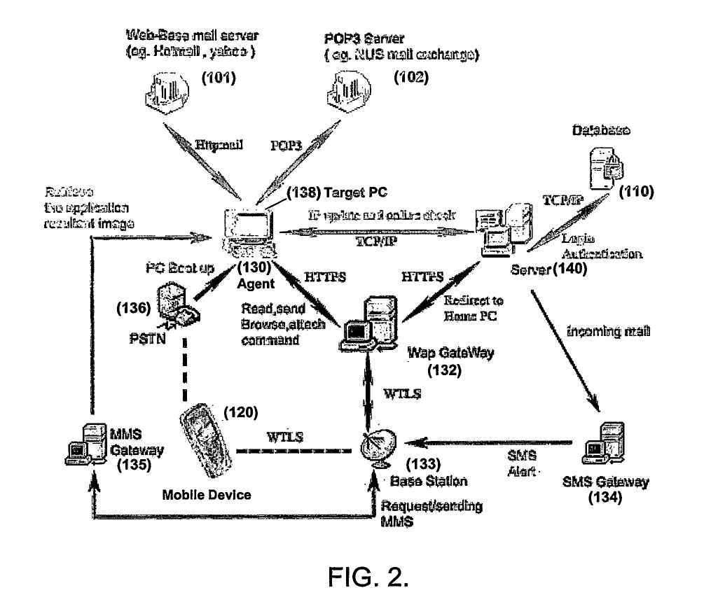

FIG. 2 illustrates in more detail an example implementation of the architecture described in FIG. 1.

With reference to FIG. 2, users for example register for the service at a designated website. After successful registration a license key will be emailed to the user. The user can then log into their given account and enter in their Mail server (101 or 102) information for example mail server name (e.g. pop.nus.edu.sg), userid and password.

The user downloads an installer that will install a target-side application in their target computer (131) (e.g. personal computers, laptop). They have to enter in the License key email to them as stated above in order for the application to function probably. It is noted that the Agent (130) as described in FIG. 1 is running on the target computer (138) in this example embodiment.

The installed software will setup a WAP Server (not shown in FIG. 2.) at the target computers (138). When the target computer device (138) goes online, the application will execute and update the database (110) at the server (140).

The functions of the server database (110) are as follows:
1) To direct user to their target computers (138) which has a dynamic IP.
2) To authenticate the user.
3) To administer the users profile.

When the user login to the Server (140) using the mobile devices (e.g. mobile phone and PDA) via WAP, after verification the user will then be redirected to his/her own target computer (138). The Java server application running on the target WAP Server will allow the target to link his Mail server POP/IMAP/Web-based (101 or 102), e.g. (Hotmail and Yahoo! mail). The application will also allow the user to access all folders in the target computer (138) and send any file as attachment. The application also allows the attachment file in the received E-mail or in the PC to be viewed as image or text. There is also a zoom function to enlarge the image. The User ID and the password for the Mail server (101 or 102) will be encrypted and stored in the server database (110). After successful authentication, the encrypted user ID and the password for the Mail server (100) (e.g. Yahoo!, Hotmail) will be sent to the target computer (138). At the target computer (138), a de-encryption process will take place to obtain the user ID and password necessary for establishing connection with the Mail server (101 or 102) (e.g. Yahoo!, Hotmail). This will relieve the user from the chore of having to enter the data on the mobile device (120) (e.g., mobile phone and PDA).

The overall network also comprises three gateways in the example embodiment.

A Short Messaging Service (SMS) gateway (134) is set up to send SMS messages to the user mobile device (120) when they receive an incoming mail. This will enable the user to respond immediately to incoming mail.

A Messaging Service (MMS) gateway (135) is setup to allow the user to view image file attachments on the mobile device.

A WAP Gateway (132) is setup to establish connection between the Target computer (138) and Server (140) to the Mobile Device (120) via a Base station (133). It is also used for redirecting the server (140) to the targeted PC intended by the user and to pass email commands such as read, send, browse and attach from the Target computer (138) to the mobile device (120).

The user is able to boot up their computer device (138) (e.g. personal computers, laptop) at home via the Basic Input/Output System (BIOS) wale on ring function through a Public Switched Telephone Network (PSTN) (136). However, allowing the wake on ring function to be enabled may prove to be a nuisance, as the target computer (138) will boot up whenever there is a call. Thus, in the example embodiment, an authentication black box is constructed. It works on the dial-tone principle that will authenticate the user before booting up the computer via wake on ring function.

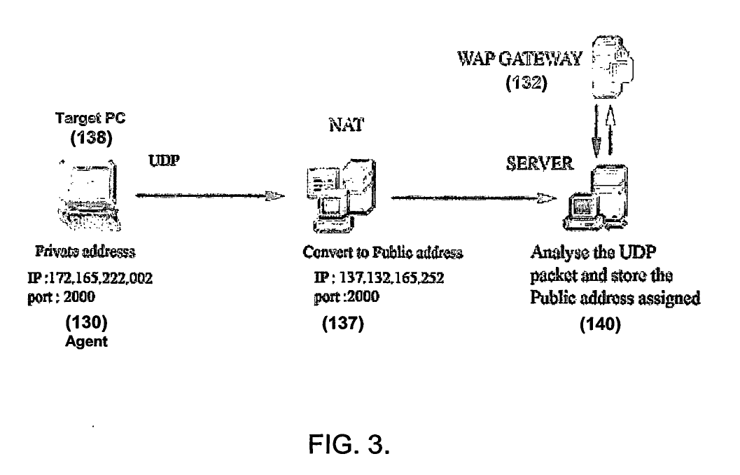

FIG. 3 shows the operations of the method for solving the Network Address Translation (NAT) problem in the example embodiment.

With reference to FIG. 1 and FIG. 3, as mentioned in the previous section, any external computer on the Internet cannot latch onto a LAN TARGET PC's (138) IP address and use it to connect to its port. This creates a problem with the distributed system architecture used, as a WAP gateway (132) will initiate the connection to the LAN TARGET PC (138) via updated IP address. To overcome this problem the following method is used in an example embodiment.

The Agent (130) residing on the LAN TARGET PC (138) will send a User Datagram Protocol (UDP) packet at every one minute interval to the Server (140) that is located outside the LAN network. The Agent (130) will operate at the port number assigned in the UDP packet Source port. This will allow the Agent (130) to be contactable by any external computer, as the LAN TARGET PC (138) and the port at which the agent (130) run have an entry in the NAT Table (137). From the UDP packet received, the Server (140) will be able to determine the translated address given to the LAN TARGET PC (138). The WAP gateway (132) will contact the Server (140) in the same manner as any external computer to retrieve the translated IP address to the Agent (130).

It is noted that the example embodiment thus employs a distributed system implementation. The Server (140) in the example embodiment is only responsible for limited transmissions in relation to e.g. authentication and redirection. The mobile-email functional transmissions, such as reading or sending e-mails or attaching files to e-mails, go through the Agent (130) and the mobile device (120). This provides a saving in resources and scalability.

File Conversion Technique

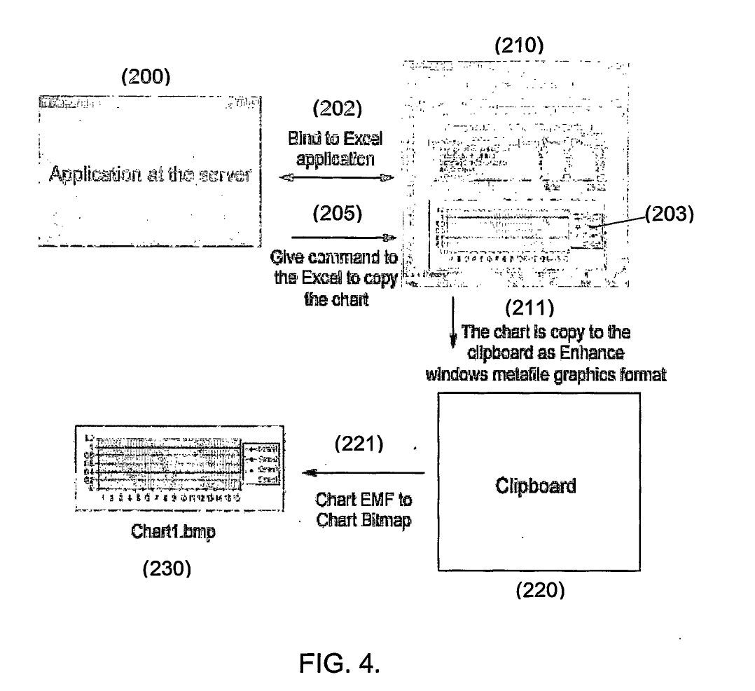

To read an attachment in the received E-mail using all types of mobile devices, the attachment files have to be converted to image file format or text file format. In the example embodiment, a fast method to convert Microsoft Office applications is devised. Microsoft Office documents like Excel, PowerPoint and Word are compound documents. Compound documents have the Object Linking and Embedding (OLE) feature that allows raw data to be copied to clipboard and to join parts of two documents together. The clipboard function provides a mean to convert a Microsoft Office file to an image file easily. When part of the compound document is copied to the clipboard, the object is stored in one or more of the clipboard formats. One of the clipboard formats that the object is stored in is the Enhanced Windows metafile graphic format (EMF). EMF, as the name suggests, is a metafile graphics that contain both raster and vector data. The object is stored as a vector with bitmap attributes. Using for example Windows Graphics and Multimedia API, or Java API, or Graphics Device Interface API, the EMF file can be converted to bitmap file. FIG. 4 illustrates the process as described.

FIG. 4 shows a method of converting a part of a compound document (e.g. a chart in a Microsoft Excel compound document) into an image file, which is readable on mobile devices.

At the start, there exists an application (200) running on a server in a network. At a target location, which can be a remote computer, server or a mobile device, there exists another application (210), for example in FIG. 4, a Microsoft Office application such as Excel.

The method comprises, firstly, the application (200) binding itself to the Excel application (210). The step of binding (202) allows both applications to gain access to each other's resources.

After binding (202), the application (200) gives a command to the Excel application to copy for example a chart (203) within a running compound document at step (205).

After the copy command is issued at step (205), the chart (203) is copied, at step 211, to the clipboard (220) residing on the target location as an Enhanced Windows metafile graphics Format (EMF) or in other format with equivalent nature as EMF.

The next step (221) comprises file conversion by converting the chart in EMF to a chart in image format such as bitmap (230) shown in FIG. 4. For example, the file conversion technique may comprise converting EMF in the clipboard (220) to image format via e.g. Graphics API on the application (200) running on the server.

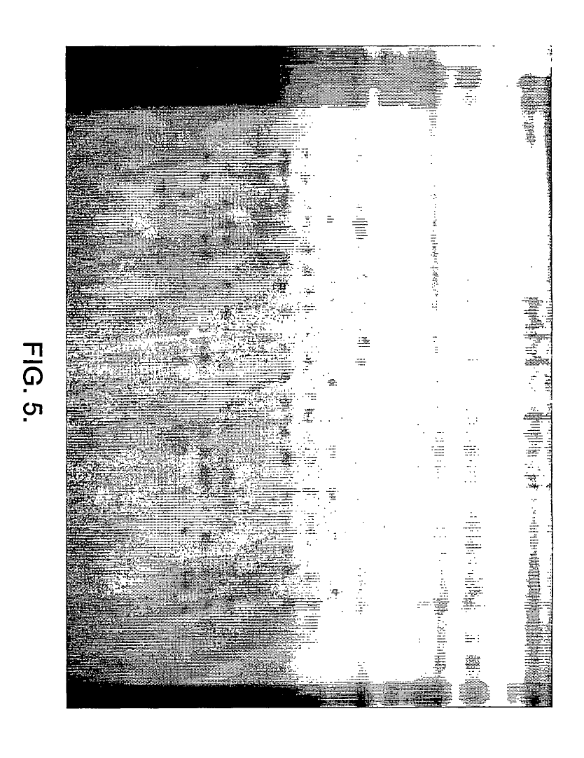

The converted image size in terms of pixel height and width is too large for the cellular phone display screen. After conversion the image size is usually several hundreds pixels in dimension. The cellular phone display screen is only about 200×200 pixels, thus resampling is needed. Resampled images have undesirable artefacts, such as distortion of straight lines. As most alphabets contain fine straight lines, this poses a serious problem to the viewability of the resultant image. The distortion is severe when the scaling factor is high as shown in FIG. 5.

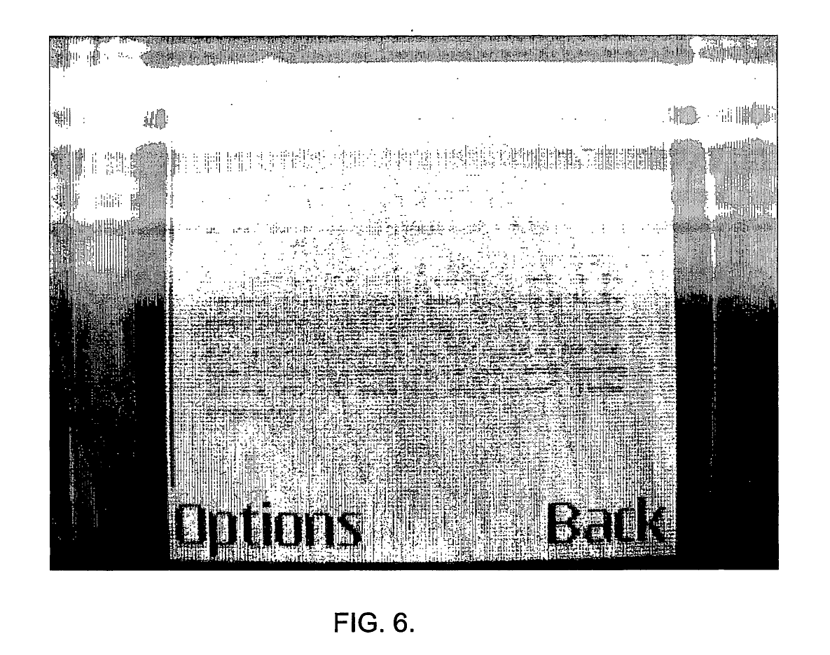

Gaussian blur is adopted to smoothen out these artefacts in the example embodiment. In the Gaussian blurring process, each pixel in the RGB image is mixed with its adjacent neighboring pixel with Gaussian probability. Thus, the pixel nearer will have a greater effect on the desired pixel. The amount of affected pixels on either side is determined by the convolution radius specified. By blurring the image before performing resampling, the fine details will be “enlarged” and remain visible after resampling. The size of the convolution radius used is dependent on the resampling scale factor. An adaptive algorithm is used to blur the image according to the resampled scale factor size. FIG. 6 shows the improved image.

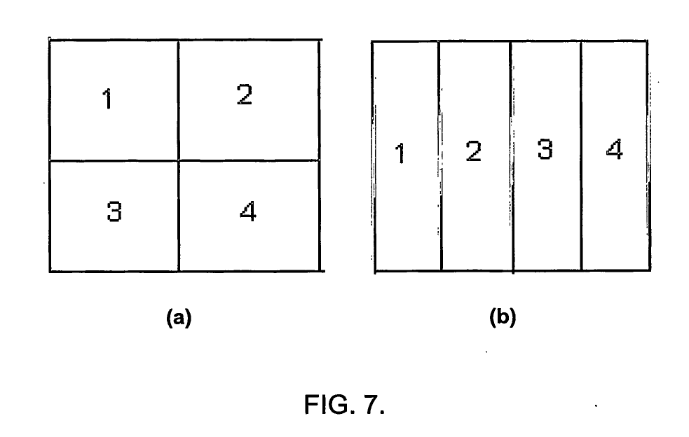

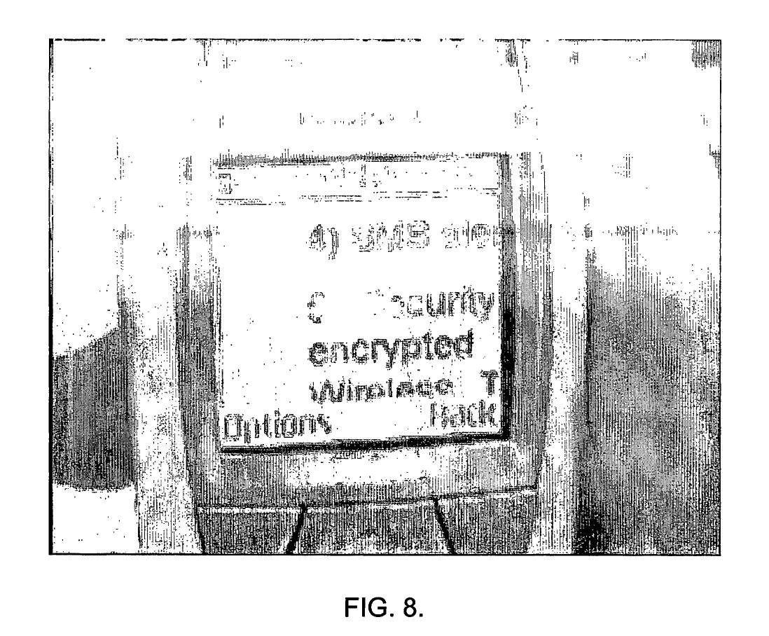

Despite the image processing effort, the resultant image is at best only passable. To improve on the readability of the converted document, a Zoom function needs to be introduced. The Zoom function allows the user to enlarge the area of interest by selecting one of the regions 1, 2, 3 or 4 from FIG. 7a or FIG. 7b. The selected region will then be crop from the original image. As crop images have a lesser number of pixels, the resample scale factor will be small and the image will appeared magnified as shown in FIG. 8. FIG. 7 shows 2 types of sectioning the original image. FIG. 7a is used when dealing with picture based image, while FIG. 7b is used for text base image.

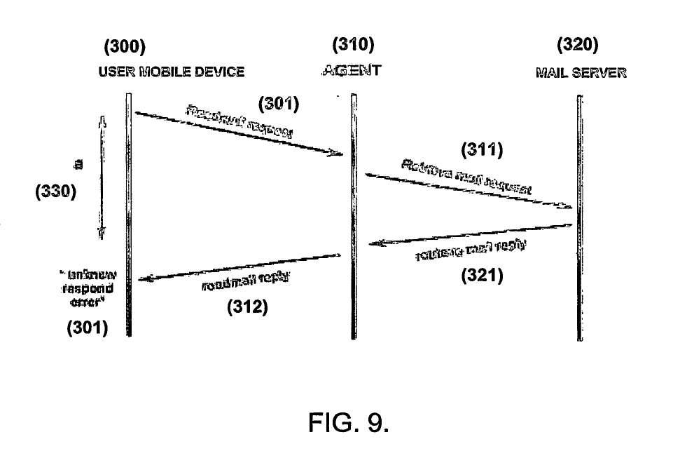

One of the problems faced by the Agent in the example embodiment is the premature timeout termination by the WAP gateway. When the Agent executes a time consuming task, for example retrieving email from the Mail server, the time needed to perform this process can exceed the timeout assigned by the WAP gateway, thus causing an “unknown response” error. This is illustrated in FIG. 9.

At the start, a user mobile device (300) sends a Readmail request (301) to an Agent (310).

Upon receiving the Readmail request (301), the Agent (310) sends a Retrieve mail request (311) to a Mail Server (320).

After receiving the Retrieve mail request (311), the Mail Server (320) sends a retrieve mail reply (321) to the Agent (310). By the time the Agent (310) receives the retrieve mail reply (321), the WAP gateway timeout, a (330), has already expired.

Thus, when the Agent (310) sends the Readmail reply (312) to the user mobile device (300), the user mobile device will have an unknown respond error (302).

To resolve the problem, a “time buffer” code is additionally introduced in the example embodiment. The following shows a pseudo code readbuffer class:

<Begin Wireless Markup Language coding>

<Timer start>

<On event timeup>

<Goto actual read class>

<End Wireless Markup Language coding>

ConnectHotmail

Timeout occurred

ReadHotmail

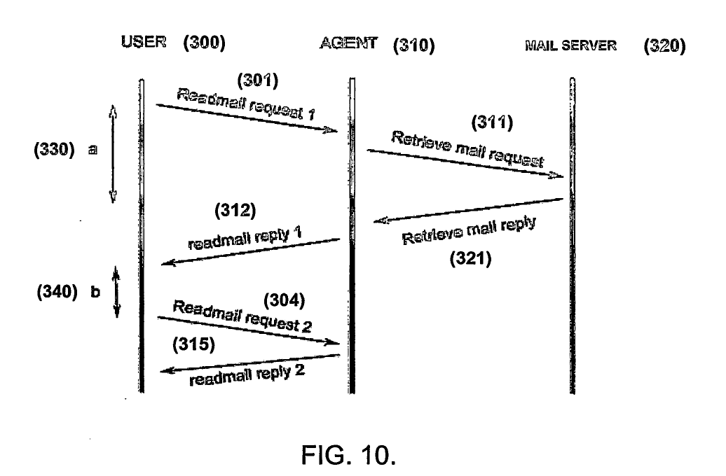

When the read class file is run, it will first generate the Wireless Markup Language (WML) code. During the first time execution of the connect Hotmail procedure “ReadHotmail”, the timeout of the WAP gateway is reached and the connection between the WAP gateway and the Agent will be lost, but the transaction between the Agent and the Hotmail server can still carry on. The WML code generated will be downloaded to the user hand-held mobile device and be executed. The WML code will direct the hand-held mobile device back to the Agent after 30 seconds. By then, the execution of “ReadHotmail” procedure will be completed and the user will be able to read the email. FIG. 10 shows the effect of the buffer.

When a user wishes to read an e-mail, he/she activates his/her user mobile device (300) to send a Readmail request 1 (301) to the Agent (310).

Upon receiving the Readmail request 1 (301), the Agent (310) sends a Retrieve mail request (311) to the Mail Server (320).

After receiving the Retrieve mail request (311), the Mail Server (320) sends a Retrieve mail reply (321) to the Agent (310). Although by this time, the WAP gateway timeout, a (330), has already expired, the Agent (310) continues to send a Readmail reply 1 (312) to the user mobile device (300).

As in the example embodiment a WML code is executed to configure the user mobile device (300) to revert to the Agent (310), e.g. after 30 seconds from when the time a (330) expires, there is a new time period, b (340), whereby the user mobile device (300) will accept responses from the Agent (310). The period b may e.g. last until the next WAP gateway timeout, or e.g until the user disconnects.

Therefore, unlike the case illustrated in FIG. 9, the e-mail reading procedure is completed as the user mobile device (300), Agent (310) and Mail Server (320) successfully receive all necessary responses. The user is then able to read the e-mail.

After reading the first e-mail, the user may activate his/her user mobile device (300) to send a Readmail request 2 (304) and receive its corresponding response readmail reply 2 (315) to read a second e-mail.

Embodiments of the present invention can provide the following advantages:

1) To manage an unlimited number of POP3/IMAP/Web-based (e.g Yahoo!/Hotmail) email accounts.

2) To allow users to access all the files in the computer devices (e.g. personal computers, laptop) and send the files as attachment with the email composed via mobile devices (e.g mobile phone).

3) To allow users to ZIP up the file before sending them off as attachment.

4) Uses Short Message Service (SMS) alert for incoming email

5) Security of the email is ensured as user data is encrypted and the email message is sent via the Wireless Transport Layer Security (WTLS) protocol to the mobile devices (e.g. mobile phone and PDA).

6) An authentication black box that works on the dial-tone principle to authenticate the user before booting up the computer devices (e.g. personal computers, laptop) via wake on ring function.

7) Uses a fast file conversion method to convert Microsoft Office files to image file format. Thus, it allows Word, Excel, or PowerPoint attachments in the email to be viewed in the hand-held mobile devices as image file.

8) Employs novel image processing techniques to improve the quality of the resample image. This allows the converted image to be viewed and stored in cellular phone with small screen display.

9) Uses a zoom function that allows the Image to be enlarged.

10) Distributed architecture for establishment of connection between hand-held mobile devices and the remote PC with a soft approach to deal with WAP gateway timeout.

In the foregoing manner, a complete mobile email management system and method based on WAP (Wireless Application Protocol) E-mail service is disclosed. Only embodiments are described. However, it will be apparent to one skilled in the art in view of this disclosure that numerous changes and/or modifications may be made without departing from the scope of the invention.

1. A method for e-mail management utilising a mobile device, the method comprising the steps of:
establishing a link between the mobile device and a computer device; establishing a link between the computer device and a mail server;
browsing through data files on the computer device, under the control of the mobile device; and
attaching one or more of the data files, under the control of the mobile device, to an e-mail to be send utilising the mail server.

2. The method as claimed in claim 1, wherein the step of establishing the link between the mobile device and the computer device comprises the steps of:
establishing a link between the mobile device and an authentication server;
verifying, at the authentication server, identification information provided through the mobile device; and
establishing the link between the mobile device and the computer device upon successful verification.

3. The method as claimed in claim 2, further comprising the steps of:
instructing the computer device to periodically send a User Datagram Protocol (UDP) packet to the authentication server when on-line;
extracting, at the authentication server, a public Internet Protocol (IP) address allocated to the received UDP packets; and
utilizing the extracted public IP address for establishing the link between the mobile device and the computer device.

4. The method as claimed in claim 2, the method further comprising the step of monitoring the arrival of new e-mails at the mail server
and sending one or more messages to the mobile device when there are new e-mails.

5. The as claimed in any one of claims 4, wherein the authentication server monitors the arrival of new e-mails at the mail server and sends one or more messages to the mobile device when there are new e-mails.

6. The method as claimed in claim 1, the method further comprising the step of downloading a data file attached to an e-mail received at the mail server to the mobile device for viewing.

7. The method as claimed in claim 6, the method further comprising a file conversion technique to convert the data file to an image file.

8. The method as claimed in claim 7, wherein the file conversion technique comprises the steps of:
connecting to an application running the data file;
instructing the application to copy a fraction or whole part of the data file into a data storage; and
converting the fraction or whole part of the data file stored in the data storage to the image file using an Application Programming Interface (API).

9. The method as claimed in claim 7, the method further comprising an image processing technique to resample the image file so as to create a clearer image of the image file when viewed on the mobile device.

10. The method as claimed in claim 9, the image processing technique further comprises employing Gaussian blurring process to smoothen out artifacts on the image file.

11. The method as claimed in claim 7, wherein the mobile device comprises a zoom function to improve readability of the image file.

12. The method as claimed in claim 11, wherein the zoom function segments the image of the image file when viewed on the mobile device into one or more selectable regions.

13. The method as claimed in claim 12, wherein one of the selected regions is cropped from the image of the image file when viewed on the mobile device and magnified for viewing on the mobile device.

14. The method as claimed in claim 12, wherein the image is segmented with a single row of one or more columns for text base images.

15. The method as claimed in claim 12, wherein the image is segmented with two or more rows and two or more columns for picture base images.

16. The method as claimed in claim 1 wherein the mobile device resumes a network gateway connection after an assigned access time on the network gateway maintaining the connection has expired.

17. The method as claimed in claim 16, wherein a WML code is downloaded into the mobile device for resuming the network gateway connection after the assigned access time on the network gateway maintaining the connection has expired.

18. The method as claimed in claim 1 wherein a user of the mobile device boots up the computer device utilizing the wake on ring function of the computer device.

19. The as claimed in claim 18, the method further comprising an authentication device working on dial-tone principle that will authenticate the user before booting up the computer device utilizing the wake on ring function of the computer device.

20. A system for e-mail management, the system comprising:
a computer device;
a mail server;
a mobile device;
an agent on the computer device to, under the control of the mobile device, browse through data files on the computer device and attach one or more of the data files to an e-mail to be sent utilising the mail server.

21. The system as claimed in claim 20, further comprising an authentication server, wherein the mobile device establishes a link to the authentication server; the authentication server verifies identification information provided through the mobile device and establishes the link between the mobile device and the computer device upon successful verification.

22. The system as claimed in claim 21, wherein the computer device, in an on-line state, periodically sends a User Datagram Protocol (UDP) packet to the authentication server, under the control of the agent.

23. The system as claimed in claim 22, wherein the authentication server extracts a public Internet Protocol (IP) address allocated to the received UDP packets and utilizes the extracted public IP address for establishing the link between the mobile device and the computer device.

24. The as claimed in claim 21, wherein the authentication server monitors the arrival of new e-mails at the mail server and sends one or more messages to the mobile device in response to receipt of new e-mails.

25. The system as claimed in claim 20, wherein the mobile device downloads and views a data file attached to an e-mail received at the mail server.

26. The system as claimed in claim 25, wherein the system utilizes a file conversion technique to convert the data file to an image file.

27. The system as claimed in claim 26, wherein the file conversion technique comprises the steps of:
connecting to an application of the system running the data file;
instructing the application to copy a fraction or whole part of the data file into a data storage; and
converting the fraction or whole part of the data file stored in the data storage to the image file using an Application Programming Interface (API).

28. The system as claimed in claim 26, the system further utilizes an image processing technique to resample the image file so as to create a clearer image of the image file viewed on the mobile device.

29. The system as claimed in claim 28, the image processing technique further comprises employing Gaussian blurring process to smoothen out artifacts on the image file.

30. The system as claimed in claim 26, wherein the system utilizes a zoom function to improve readability of the image file.

31. The system as claimed in claim 30, wherein the zoom function comprises segmenting the image of the image file.

32. The system as claimed in claim 31, wherein a selected region is cropped from the image of the image file and magnified for viewing on the mobile device.

33. The system as claimed in claim 31, wherein the image is segmented with a single row of one or more columns for text base images.

34. The system as claimed in claim 31, wherein the image is segmented with two or more rows and two or more columns for picture base images.

35. The system as claimed in claim 20, wherein the mobile device resumes a network gateway connection after an assigned access time on the network gateway maintaining the connection has expired.

36. The system as claimed in claim 35, wherein the mobile device executes a WML code for resuming the network gateway connection after the assigned access time on the network gateway maintaining the connection has expired.

37. The system as claimed in claim 20, wherein the mobile device boots up the computer device utilizing the wake on ring function of the computer device.

38. The system as claimed in claim 37, the computer device authenticates the mobile device before booting up.

39. A data storage device containing computer readable code means for instructing a computer system to execute a method for e-mail management utilising a mobile device, the method comprising the steps of:
establishing a link between the mobile device and a computer device;
establishing a link between the computer device and a mail server;
browsing through data files on the computer device, under the control of the mobile device, and attaching one or more of the data files, under the control of the mobile device, to an e-mail to be send utilising the mail server.
